(19) United States
(12) Patent Application Publication
(10) Pub. No.: US 2006/0090312 A1
(43) Pub. Date: May 4, 2006

(54) Tongue cover and seat belt apparatus using the same

(75) Inventors: Yoshiyuki Ichida, Echi-gun (JP); Norio Matsumura, Hikone-shi (JP); Yuichi Sawatari, Hikone-shi (JP); Toshiyuki Konishi, Gamou-gun (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/242,040

(22) Filed: Oct. 4, 2005

(30) Foreign Application Priority Data
Oct. 28, 2004 (JP) 2004-313434

(51) Int. Cl. A44B 11/25; B60R 22/00; B60R 22/18

(52) U.S. Cl. 24/633; 280/801.1; 297/482

(57) ABSTRACT

A tongue cover is attached to a grip of a seatbelt tongue such that the tongue cover covers edges of the grip except for an edge to which a plate is attached. The tongue cover may be formed of synthetic resin or rubber that is softer than a resin mold of the grip. The tongue cover, which acts as a cushion, prevents the grip from directly impacting the trim on the inner side wall of a vehicle, thereby substantially reducing the likelihood that the trim will be scratched and/or dented. Moreover, the tongue cover also substantially reduces and/or eliminates noise that is typically caused when a tongue directly impacts trim on the inner side of a vehicle, in the absence of such a tongue cover.

### BACKGROUND

The present invention relates to a tongue cover for a tongue used in, for example, a seatbelt apparatus that is configured to protect an occupant seated in a vehicle such as an automobile, and/or a safety belt apparatus that is configured to a protect field worker. More specifically, the present invention relates to a tongue cover that is used to protect objects (in the surrounding area) that may otherwise be harmed when the tongue hits such objects. In addition, the present invention relates to a seatbelt apparatus that has a tongue to which a tongue cover can be attached or with which a tongue cover is integrally formed.

Conventionally, seatbelt apparatuses, which are mounted on a vehicle such as an automobile, are configured to prevent an occupant from being displaced by inertia during an impact, thereby protecting the occupant when a large deceleration force is applied to the vehicle. Such conventional seatbelt apparatuses include, for example, the three-point seatbelt apparatus shown in FIG. 5. In the figure: (a) reference numeral 1 denotes a seatbelt apparatus that is installed in a vehicle seat 2; (b) reference numeral 3 denotes a seatbelt retractor that is fixed to the chassis in the vicinity of the vehicle seat 2; (c) reference numeral 4 denotes a seatbelt; (d) reference numeral 5 denotes a tongue that is slidably supported by the seatbelt 4; (e) reference numeral 6 denotes a buckle, which releasably engages the tongue 5 and which fixed to the vehicle seat 2 or the chassis; and (f) reference numeral 7 denotes a belt guide that is fixed to the upper side of the vehicle, for example, to a center pillar 8.

In a normal situation, the seatbelt retractor 3 retracts the seatbelt 4 in a manner such that the seatbelt 4 can be withdrawn. The seatbelt 4, which is withdrawn from the seatbelt retractor 3, is guided by the belt guide 7. An end 4a of the seatbelt 4 withdrawn from the seatbelt retractor 3 is fixed to the vehicle seat 2 or the chassis. During an emergency, however, the seatbelt retractor 3 substantially prevents the seatbelt 4 from being withdrawn.

In the seatbelt apparatus 1 as above configured, when an occupant sitting in the vehicle seat 2 fastens the seatbelt 4, the occupant withdraws the seatbelt 4 from the seatbelt retractor 3, engages the tongue 5 with the buckle 6, and then releases his or her hand from the tongue 5. Next, the seatbelt retractor 3 retracts the seatbelt 4 to tighten it. In this way, the seatbelt 4 is fastened.

Conventional tongues 5 have a metal plate 5a and a grip 5b. The plate 5a has a hole 5a₁. When the plate 5a is inserted into the buckle 6, a latch (not shown) of the buckle 6 engages with the hole 5a₁, to lock the plate 5a in the buckle 6. The grip 5b, which is formed by resin molding on a part of the plate 5a, is gripped by an occupant in order to insert and lock the tongue 5 in the buckle 6. The seatbelt 4 passes through a belt hole 5b₁, in the grip 5b.

When the seatbelt 4 is not fastened, the seatbelt 4 is fully retracted by the seatbelt retractor 3 such that the entire seatbelt 4 (from the belt guide 7 to the end 4a) is located along the inner side wall of the vehicle. Therefore, the tongue 5, which is supported by the seatbelt 4, is located near the inner side wall. As a result, if the tongue 5 is hit by an incoming or outgoing occupant, the tongue 5 may be driven into the trim on the inner side wall of the vehicle. Moreover, when the occupant exits the vehicle, the occupant typically releases the tongue 5 (with the seatbelt 4 affixed thereto) from the buckle 6 and releases his/her hand from the tongue 5 such that the seatbelt 4 is retracted. During this retraction, the tongue 5, which is pulled up by the seatbelt retractor 3, may hit the trim on the inner side wall of the vehicle. In either scenario, if the tongue 5 hits the trim on the inner side wall of the vehicle: (a) the trim can be scratched and/or dented by the tongue 5; and/or (b) an undesirable noise may be generated.

To prevent the trim from being scratched and/or dented (and to prevent the generation of undesirable noise), JP Patent No. 3,055,228 (i.e., U.S. Pat. No. 5,214,827 (“Yamanishi”)) proposed a different tongue of a seatbelt apparatus. Yamanishi's tongue has a telescopic cover for covering the plate 5a of the tongue 5. When the tongue is inserted and locked in the buckle, the telescopic cover collapses. Unfortunately, as a result of the very complex structure Yamanishi's telescoping tongue cover, the cost of the structure is high. Moreover, the telescoping nature of the tongue cover also makes it difficult for an occupant to insert the tongue into the buckle smoothly, i.e., the tongue is not user-friendly.

When a conventional tongue is released from a buckle, the grip 5b of the tongue 5 supported by the seatbelt 4 is closer to the trim on the inner side wall of the vehicle than the plate 5a and, therefore, the grip 5b often hits the trim. Yamanishi's tongue cover, however, only covers the tongue plate 5a of the tongue 5, i.e., the grip 5b remains uncovered. Therefore, Yamanishi's tongue cover does not prevent the grip from scratching and/or denting the trim (or from making undesirable noise when impacting the trim).

In addition, as Yamanishi's cover is not detachable, even if the user does not want the cover, the user is forced to accept the tongue with the cover. In other words, as Yamanishi's cover is not an optional, detachable part, the tongue can not be attached (or detached) according to a particular request by a dealer or an end user.

Accordingly, the present invention has been made in light of the aforementioned problems. An object of the present invention is to provide a tongue cover that, when the tongue hits objects in the surrounding area, can (a) sufficiently prevent the objects from being scratched and/or dented and/or (b) substantially inhibit the generation of undesirable noise. Another object of the present invention is to improve the operability of the tongue cover, while reducing the manufacturing cost thereof.

Another object of the present invention is to provide a tongue cover that can be attached and detached according to a request by a dealer or an end user. Another object of the present invention to provide a seatbelt apparatus that employs a tongue cover of the type previously described.

### SUMMARY

An embodiment of the invention addresses a tongue cover for a tongue, the tongue including, among other possible things: a plate that is configured to engage a buckle; and a grip that is configured to facilitate engagement of the plate with the buckle. The grip is integral with the plate and is configured to be slidably supported by a belt. The tongue cover, which is formed of a material that is softer than the grip, is provided on the grip in a manner such that the tongue cover covers edges of the grip except for an edge to which the plate is attached.

In a further embodiment of the tongue cover, the tongue cover may be integral with the grip of the tongue. For example, the tongue cover may be integrally molded with the grip of the tongue via a resin mold. Further, the tongue cover may not be detachable. The tongue may be smoothly inserted and locked in the buckle and, therefore, the seatbelt may be easily fastened.

In another further embodiment of the tongue cover, the tongue cover may be separate from the tongue. Further, the tongue cover may be attached to the grip of the tongue. Further still, the tongue cover may be detachable from the tongue. Therefore, the tongue cover may be an optional part to be attached later by a dealer or an end user.

In another further embodiment of the tongue cover, a degree of tightness at which the tongue cover holds the grip of the tongue may be adjustable. Therefore, the tongue cover may be attached to the tongue at a desired degree of tightness and/or may be prevented from being displaced from a proper position.

In another further embodiment of the tongue cover, the tongue cover may include: a first binding band that has a first engaging portion; and a second binding band that has a second engaging portion, which is configured to engage the first engaging portion.

In another further embodiment of the tongue cover, the first engaging portion may be in the form of a button hole and the second engaging portion may be in the form of a button.

In another further embodiment of the tongue cover, the first and second engaging portions may be respective joining members. Further, the joining members may be respective pieces of Velcro®.

In another further embodiment of the tongue cover, the first engaging portion may be in the form of a male snap fastener the second engaging portion may be in the form of a female snap fastener.

Another embodiment of the present invention addresses a seatbelt apparatus that includes, among other possible things: (a) a seatbelt; (b) a seatbelt retractor for retracting the seatbelt; (c) a buckle; (d) a tongue that is slidably supported by the seatbelt and that is configured to be inserted in, and releasably engaged with, the buckle to fasten the seatbelt, the tongue including, among other possible things: (i) a plate that is configured to engage the buckle; and (ii) a grip that is configured to facilitate engagement of the plate with the buckle; and (e) a tongue cover for the tongue. The grip is integral with the plate and is slidably supported by the seatbelt. The tongue cover, which is formed of a material that is softer than the grip, is provided on the grip in a manner such that the tongue cover covers edges of the grip except for an edge to which the plate is attached. The tongue cover is attached to or is integral with the tongue.

In a further embodiment of the seatbelt apparatus, a degree of tightness at which the tongue cover holds the grip of the tongue is adjustable.

In another further embodiment of the seatbelt apparatus, the tongue cover may include: a first binding band that has a first engaging portion; and a second binding band that has a second engaging portion, which is configured to engage the first engaging portion.

In another further embodiment of the seatbelt apparatus, the first engaging portion may be in the form of a button hole and the second engaging portion may be in the form of a button.

In another further embodiment of the seatbelt apparatus, the first and second engaging portions may be respective joining members. Further, the joining members may be respective pieces of Velcro®.

In another further embodiment of the seatbelt apparatus, the first engaging portion may be in the form of a male snap fastener the second engaging portion may be in the form of a female snap fastener.

In this embodiment, when the tongue is located near the inner side wall of the vehicle, if the grip of the tongue is driven by an incoming or outgoing occupant into the trim on the inner side wall of the vehicle, the tongue cover contacts the trim, thereby protecting the trim from the tongue. Similarly, after an occupant releases the tongue from the buckle (when unfastening the seatbelt in order to get out of the vehicle), if the grip of the tongue contacts the trim on the inner side wall of the vehicle (when the seatbelt is retracted by the seatbelt retractor), the tongue cover protects the trim from the tongue. In other words, the tongue cover, which is formed of a relatively soft material, functions as a cushion. Therefore, when the tongue cover contacts the trim, the trim can be effectively prevented from being scratched and/or dented. In addition, an undesirable noise made at the time of impact can be absorbed.

As previously described, the tongue cover of the present invention is formed of a material that is softer than the grip and may be attached to the grip in a manner such that the tongue cover covers edges of the grip except for an edge to which the plate is attached. As a result of this structure, when the tongue hits objects in the surrounding area, the tongue cover functions as a cushion. Therefore, the objects are effectively prevented from being scratched and/or dented by the tongue. Moreover, the cushiony structure also greatly inhibits the generation of undesirable noise when the tongue his such objects.

The tongue cover may be simply attached to the edges of the grip of the tongue in a manner such that the tongue cover covers the edges. Therefore, the tongue cover does not hinder the sliding between the tongue and the seatbelt supporting the tongue. As a result, in spite of the attachment of the tongue cover and unlike Yamanishi's tongue cover, the tongue can be easily inserted and locked in the buckle and, therefore, the seatbelt can be easily fastened, i.e., the operability of the tongue is greatly improved. In addition, as the tongue cover simply covers the edges of the grip of the tongue, the tongue cover can be made at low cost.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIGS. 1A and 1B, which show a first exemplary embodiment of a tongue cover according to the present invention, respectively are a perspective view that shows a tongue with the tongue cover attached and a perspective view of the tongue cover;

FIGS. 2A-2H show modifications of a first engaging portion of a first binding band and a second engaging portion of a second binding band of the exemplary embodiment shown in FIGS. 1A and 1B;

FIGS. 3A and 3B, which show a second exemplary embodiment of a tongue cover according to the present invention, respectively are a perspective view that shows a tongue with the tongue cover attached and a perspective view of the tongue cover;

FIGS. 4A and 4B, which show a third exemplary embodiment of a tongue cover according to the present invention, respectively are a perspective view that shows one side of the tongue cover and a perspective view that shows another side of the tongue cover; and

FIG. 5 is a perspective view that shows a conventional three-point seatbelt apparatus.

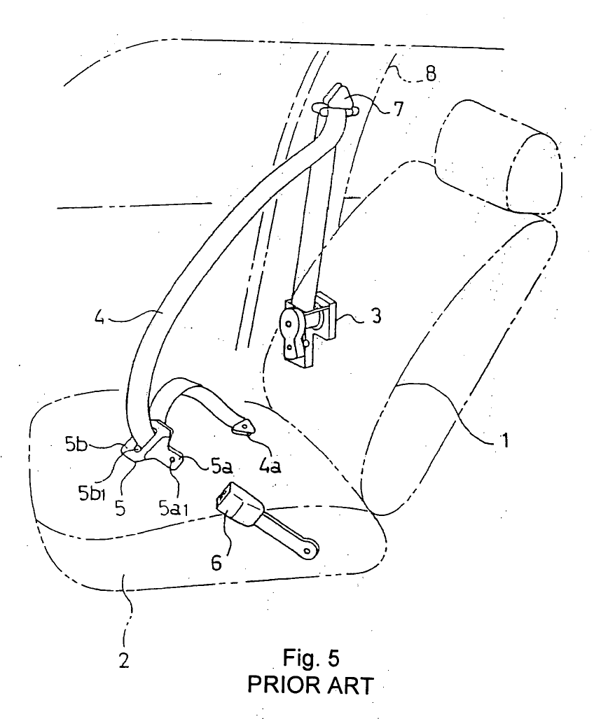

### DETAILED DESCRIPTION

Embodiments of the present invention will be described with reference to the drawings. Like numbers are used throughout the drawings to refer to the same or similar parts in the prior art previously discussed and in each of the embodiments of the invention hereafter described.

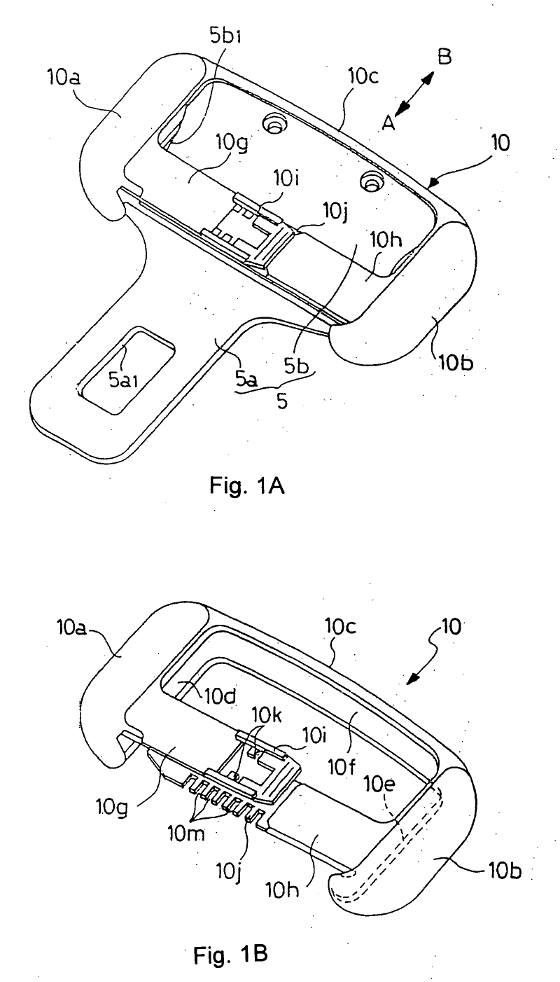

FIGS. 1A and 1B, which show an exemplary embodiment of a tongue cover 10 according to the present invention, respectively are a perspective view that shows a tongue 5 with the tongue cover 10 attached and a perspective view of the tongue cover 10.

As shown in FIGS. 1A and 1B, a tongue cover 10 is attached to a grip 5b of a tongue 5 in a manner such that the tongue cover 10 covers the edges of the grip 5b except for an edge to which a plate 5a is attached. This tongue cover 10 is U-shaped and includes left and right edge covers 10a and 10b and a middle edge cover 10c. The left and right edge covers 10a and 10b cover the left and right edges of the grip 5b of the tongue 5, respectively. The middle edge cover 10c connects first ends of the left and right edge covers 10a and 10b, and covers a middle edge on the side opposite to the edge to which the plate 5a is attached. The left and right edge covers 10a and 10b and the middle edge cover 10c have grooves 10d, 10e, and 10f, respectively, therein. The grooves have a U-shaped cross section, and connect to form a U-shape. The left and right edges and the middle edge of the grip 5b of the tongue 5 are fitted into the grooves 10d, 10e, and 10f, respectively.

From a second end of the left edge cover 10a, a first binding band 10g extends toward the right edge cover 10b parallel to the middle edge cover 10c. The first binding band 10g is integral with the left edge cover 10a. From a second end of the right edge cover 10b, a second binding band 10h extends toward the left edge cover 10a parallel to the middle edge cover 10c. The second binding band 10h is integral with the right edge cover 10b. The first and second binding bands 10g and 10h are placed opposite each other.

One of the first and second binding bands 10g and 10h (the first binding band 10g, in the shown example) has a first engaging portion 10i at the end. The other of the first and second binding bands 10g and 10h (the second binding band 10h, in the shown example) has a second engaging portion 10j at the end. The first engaging portion 10i has a pair of projections 10k. The second engaging portion 10j has a predetermined number of pairs of indents 10m. The pair of projections 10k is fitted into one of the pairs of indents 10m. The indents 10m are provided along both side edges of the second engaging portion 10j, in the longitudinal direction of the second binding band 10h, at predetermined intervals. Incidentally, FIG. 1B only shows the indents 10m provided along one side edge of the second engaging portion 10j; the indents 10m provided along the other side edge of the second engaging portion 10j are not shown because they are hidden by the first binding band 10g.

The first and second binding bands 10g and 10h are overlapped so that the pair of projections 10k is detachably fitted into one of the pairs of indents 10m. In this way, the first engaging portion 10i and the second engaging portion 10j are engaged with each other, and the left and right edge covers 10a and 10b are connected at their second ends. The degree of tightness at which the left and right edge covers 10a and 10b hold the grip 5b of the tongue 5 is adjustable by changing the pair of indents 10m in which the pair of projections 10k is fitted.

The tongue cover 10 is formed of synthetic resin or rubber. The left and right edge cover 10a and 10b, the middle edge cover 10c, the grooves 10d, 10e, 10f, the first binding band 10g, the second binding band 10h, the first engaging portion 10i, the second engaging portion 10j, the projections 10k, and the indents 10m may be integrally formed as a unit. The tongue cover 10 is formed of a material, which is softer than the resin of the grip 5b of the tongue 5, which is resistant to distortion due to temperature change, and which is highly weather-resistant, for example, a thermoplastic elastomer (“TPE”).

In the previously described tongue cover 10, when the first engaging portion 10i and the second engaging portion 10j are not engaged, the second ends of the left and right edge covers 10a and 10b can be opened (moved outward) a little, relatively easily so that the tongue cover 10 can be easily attached to the grip 5b of the tongue 5.

The tongue cover 10 has a shape such that when the occupant grips the grip 5b of the tongue 5 with the tongue cover 10 attached, he or she does not sense discomfort. Therefore, the occupant can smoothly lock the tongue 5 in the buckle 6.

How to attach the thus configured tongue cover 10 of this example to the grip 5b of the tongue 5 will hereafter be described.

With the first engaging portion 10i of the first binding band 10g and the second engaging portion 10j of the second binding band 10h not engaged, and with the second ends of the left and right edge covers 10a and 10b opened a little, the tongue cover 10 is put to the grip 5b of the tongue 5. The tongue cover 10 is put to the grip 5b in the direction shown in FIG. 1A by arrow A from upper right to lower left, that is to say, toward the plate Sa. The left and right edges and the middle edge of the grip 5b are then fitted into the grooves 10d, 10e, and 10f, respectively. Next, the first and second binding bands 10g and 10h are overlapped, and the pair of projections 10k is fitted into one of the pairs of indents 10m selected according to a desired degree of tightness. In this way, the left and right edge covers 10a and 10b are connected, and the tongue cover 10 is easily attached to the grip 5b of the tongue 5, at the desired degree of tightness.

To detach the tongue cover 10 from the grip 5b, first, the pair of projections 10k is pulled out of the pair of indents 10m, and the second ends of the left and right edge covers 10a and 10b are opened a little. Next, the left and right edges and the middle edge of the grip 5b are taken out of the grooves 10d, 10e, and 10f, respectively. At the same time, the. tongue cover 10 is moved in the direction shown in FIG. 1A by arrow B from lower left to upper right, that is to say, in the opposite direction (away) from the plate 5a. In this way, the tongue cover 10 is easily detached from the grip 5b of the tongue 5.

As previously described, the tongue cover 10 of this example is attached to the grip 5b of the tongue 5 in a manner such that the edges of the grip 5b are covered. Therefore, when a seatbelt 4 is fully retracted by a seatbelt retractor 3 and the tongue 5 is located near the inner side wall of the vehicle, if the grip 5b of the tongue 5 is driven by an incoming or outgoing occupant into the trim on the inner side wall of the vehicle, the tongue cover 10 comes into contact with the trim. Similarly, after the occupant releases the tongue 5 from the buckle 6 (to unfasten the seatbelt in order to get out of the vehicle), when the seatbelt is retracted and pulled up by the seatbelt retractor 3, the tongue cover 10 prevents the grip 5b from impacting the trim in this instance as well. In both of these scenarios, the tongue cover 10, which is formed of a relatively soft material, functions as a cushion. Therefore, when the tongue cover 10 comes into contact with the trim, the likelihood that the trim is scratched and/or dented is greatly reduced. In addition, the noise generated at the time of impact can be absorbed.

In addition, as previously described, with the second ends of the left and right edge covers 10a and 10b opened a little, the tongue cover 10 may be put on the grip 5b of the tongue 5, and the left and right edges and the middle edge of the grip 5b may then fitted into the grooves 10d, 10e, and 10f, respectively. Therefore, the tongue cover 10 can be attached to the grip 5b of the tongue 5 easily and detachably. In addition, when the tongue cover 10 is attached to the tongue 5, the tongue cover 10 can be prevented from being displaced from a proper position. Therefore, a dealer or an end user can easily attach the tongue cover 10 to the grip 5b of the tongue 5. In addition, the tongue cover 10 is a simple, optional part for later attachment.

The degree of tightness can be adjusted by changing the joining position between the first engaging portion 10i of the first binding band 10g and the second engaging portion 10j of the second binding band 10h. Therefore, the tongue cover 10 can be attached to the tongue 5 at a desired degree of tightness, and can be further prevented from being displaced from a proper position.

The tongue cover 10 is simply attached to the edges of the grip 5b of the tongue 5 in a manner such that the tongue cover 10 covers the edges. Therefore, this tongue cover 10 does not hinder the sliding between the tongue 5 and the seatbelt 4 supporting the tongue 5. Therefore, in spite of attachment of the tongue cover 10, the tongue 5 can be smoothly inserted and locked in the buckle 6, and consequently the seatbelt 4 can be easily fastened.

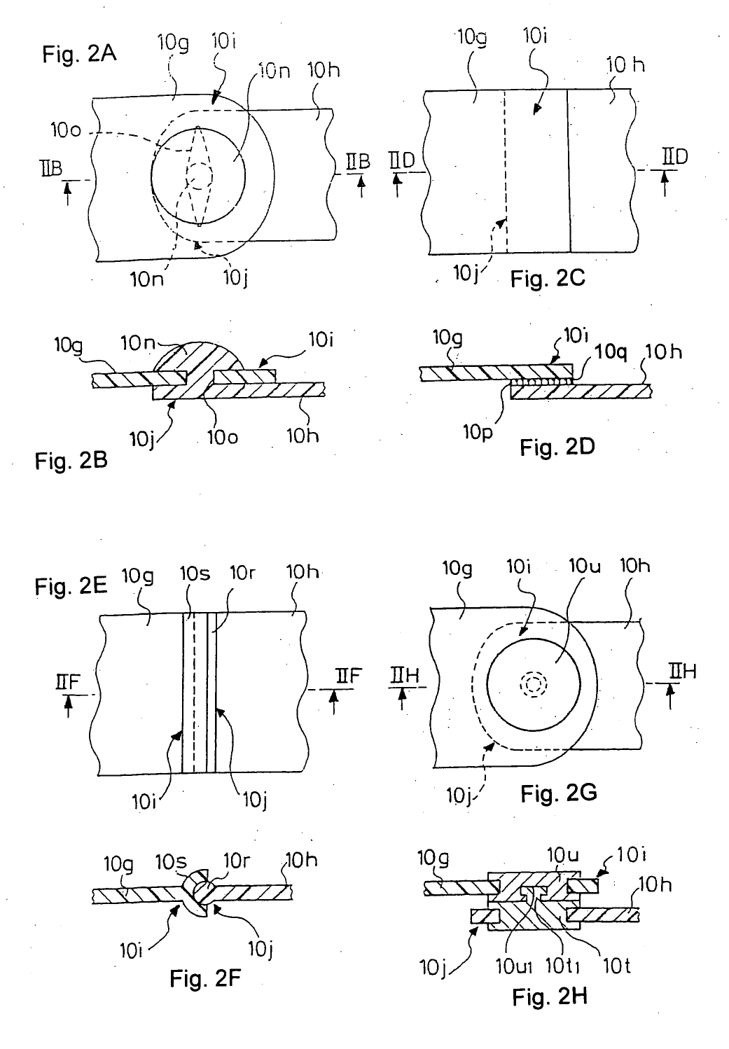

FIGS. 2A-2H show modifications of the first engaging portion 10i of the first binding band 10g and the second engaging portion 10j of the second binding band 10h of the example shown in FIGS. 1A and 1B.

In the example shown in FIGS. 1A and 1B, the first binding band 10g and the second binding band 10h are joined together by fitting the pair of projections 10k into one of the pairs of indents 10m. In the modification shown in FIGS. 2A and 2B, the second engaging portion 10j of one of the first and second binding bands 10g and 10h (the second binding band 10h, in the shown example) is provided with a button 10n, and the first engaging portion 10i of the other of the first and second binding bands 10g and 10h (the first binding band 10g, in the shown example) is provided with a buttonhole 10o. By passing the button 10n through the buttonhole 10o, the first binding band 10g and the second binding band 10h are joined in a manner such that they can be disjoined. Although not shown, in this modification, the degree of tightness can also be adjustable if a predetermined number of buttonholes are provided in the longitudinal direction of the binding band 10g in the same manner as the indents 10m of the example shown in FIGS. 1A and 1B.

In the modification shown in FIGS. 2C and 2D, the second engaging portion 10j of one of the first and second binding bands 10g and 10h (the second binding band 10h, in the shown example) and the first engaging portion 10i of the other of the first and second binding bands 10g and 10h (the first binding band 10g, in the shown example) are provided with a pair of joining members 10p and 10q. The joining members 10p and 10q have a large number of fine lines and are stuck to each other by being pressed. For example, the joining members 10p and 10q may be opposing pieces of Velcro®. By pressing the joining members 10p and 10q together, the first binding band 10g and the second binding band 10h are joined in a manner such that they can be disjoined. In this modification, the above-described degree of tightness can also be adjustable by changing the position where the joining members 10p and 10q are joined.

In the modification shown in FIGS. 2E and 2F, the second engaging portion 10j of one of the first and second binding bands 10g and 10h (the second binding band 10h, in the shown example) has a male snap fastener 10r at the end, and the first engaging portion 10i of the other of the first and second binding bands 10g and 10h (the first binding band 10g, in the shown example) has a female snap fastener 10s at the end.

The male snap fastener 10r is pressed into the female snap fastener 10s and held in it by elasticity. In this way, the first binding band 10g and the second binding band 10h are joined in a manner such that they can be disjoined. In this modification, the above-described degree of tightness cannot be readily adjusted, unless another female snap fastener 10s (or another male snap fastener 10r) is provided.

In the modification shown in FIGS. 2G and 2H, the second engaging portion 10j of one of the first and second binding bands 10g and 10h (the second binding band 10h, in the shown example) has a button-type male snap fastener 10t at the end, and the first engaging portion 10i of the other of the first and second binding bands 10g and 10h (the first binding band 10g, in the shown example) has a female snap fastener 10u at the end. The button portion 10t, of the button-type male snap fastener 10t is pressed into the hole 10u, of the female snap fastener 10u and held in it by elasticity. In this way, the first binding band 10g and the second binding band 10h are joined in a manner such that they can be disjoined. In this modification, the above-described degree of tightness cannot be readily adjusted, unless another female snap fastener 10u (or another male snap fastener 10t ) is provided.

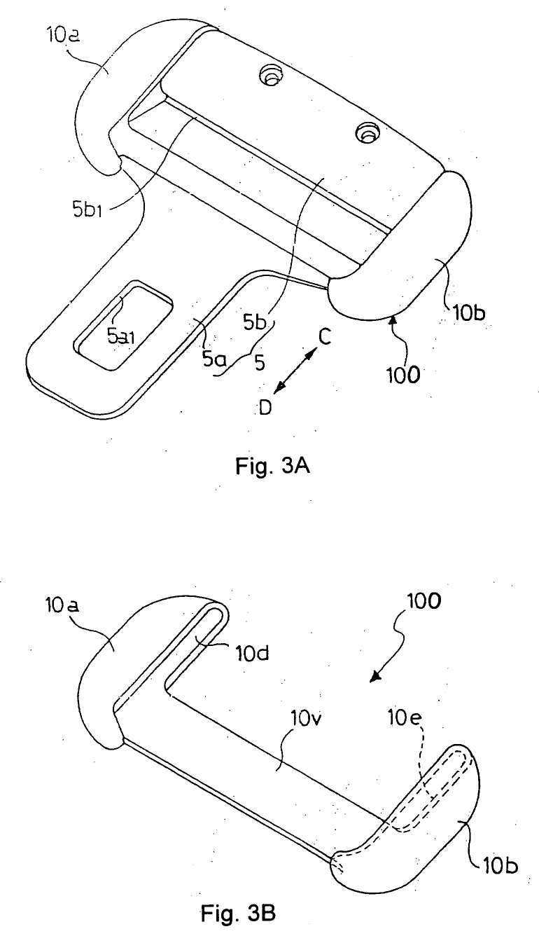

FIGS. 3A and 3B, which show another exemplary embodiment of a tongue cover 100 according to the present invention, respectively are a perspective view that shows a tongue 5 with the tongue cover 100 attached and a perspective view of the tongue cover 100.

While the tongue cover 10 shown in FIGS. 1A and 1B has a middle edge cover 10c, the tongue cover 100 of this example does not have such a middle edge cover 10c.

Moreover, the first ends of the left and right edge covers 10a and 10b are not connected, as shown in FIGS. 3A and 3B.

The tongue cover 10 shown in FIGS. 1A and 1B has the first and second binding bands 10g and 10h at the second ends of the left and right edge covers 10a and 10b. The first and second binding bands 10g and 10h have the first engaging portion 10i and the second engaging portion 10j, respectively. However, the tongue cover 100 of this example does not have such first and second binding bands 10g and 10h. Instead, the tongue cover 100 has a connecting member 10v, which always connects the second ends of the left and right edge covers 10a and 10b. Therefore, in the tongue cover 100 of this example, the above-described degree of tightness cannot be adjusted.

In the tongue cover 100 of this example, inversely with the above-described example, with the first ends of the left and right edge covers 10a and 10b opened a little, the tongue cover 100 is attached to the grip 5b of the tongue 5 in the direction shown in FIG. 3A by arrow C, and detached from the grip 5b of the tongue 5 in the direction shown in FIG. 3A by arrow D.

Other components and advantages of the tongue cover 100 of this example are the same as those of the example shown in FIGS. 1A and 1B.

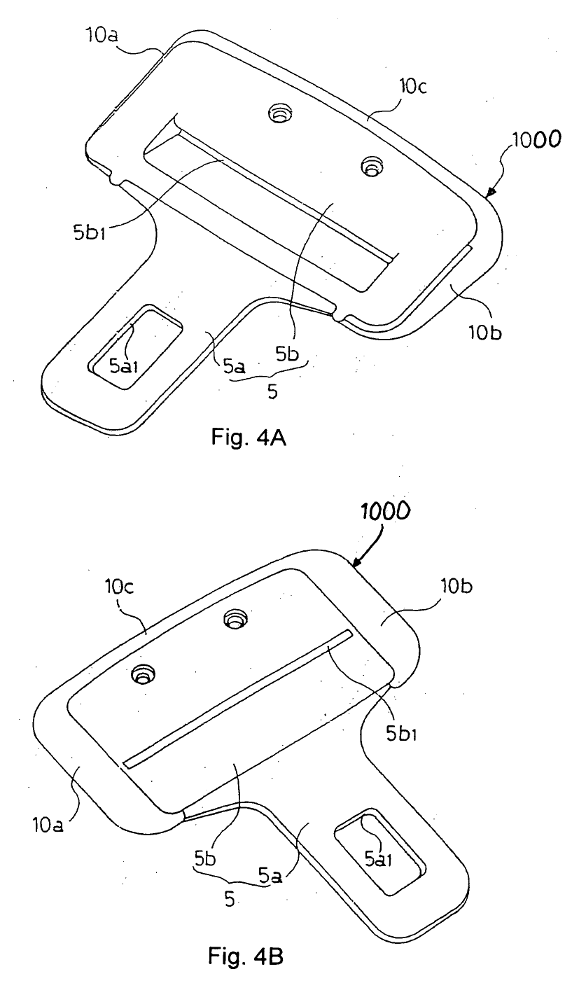

FIGS. 4A and 4B, which show still another exemplary embodiment of a tongue cover 1000 according to the present invention, respectively are a perspective view that shows one side of the tongue cover 1000 and a perspective view that shows another side of the tongue cover 1000.

The tongue covers 10, 100 of the examples shown in FIGS. 1A-1B and FIGS. 3A-3B are made separately from the tongue 5 and are attached to the grip 5b of the tongue 5 in manners such that they can be detached. On the other hand, as shown in FIGS. 4A and 4B, the tongue cover 1000 of this example is formed by, e.g., two color molding on the left and right edges and a middle edge of a resin mold constituting the grip 5b of the tongue 5. The material of the tongue cover 1000 is synthetic resin or rubber that is softer than the resin mold of the grip 5b and does not come off easily. That is to say, this tongue cover 1000 is integral with the grip 5b of the tongue 5 and is, therefore, not detachable. In addition, as in the example shown in FIGS. 1A and 1B, the tongue cover 1000 has a left edge cover 10a, a right edge cover 10b, and a middle edge cover 10c, and is U-shaped.

As the tongue cover 1000 of this example is not detachable from the grip 5b of the tongue 5, a dealer or an end user cannot readily attach the tongue cover 1000 to the grip 5b of the tongue 5. In other words, the tongue cover 1000 cannot be an optional part. In addition, as the tongue cover 1000 is molded integrally with the resin mold material of the grip 5b, there is no need to adjust the above-described degree of tightness.

The tongue cover 1000 is simply formed on the edges of the grip 5b of the tongue 5 in a manner such that the tongue cover 1000 covers the edges, is integral with the tongue 5, and is not detachable. Therefore, compared with the above-described detachable tongue covers 10, 100, the sliding between the tongue 5 and the seatbelt 4 supporting the tongue 5 can be further prevented from being hindered by this tongue cover 1000. Therefore, in spite of attachment of the tongue cover 1000, the tongue 5 can be smoothly inserted and locked in the buckle 6, and consequently the seatbelt 4 can be further easily fastened.

Other components and advantages of the tongue cover 1000 of this example are the same as those of the example shown in FIGS. 1A and 1B and FIGS. 3A and 3B.

In the above-described examples, the tongue covers of the present invention are applied to a tongue of a seatbelt apparatus installed in vehicles such as an automobile. However, the present invention is not limited to this, and can also be applied to a tongue cover used for a tongue of a safety belt apparatus for protecting a field worker. When the tongue hits objects in the surrounding area, the tongue cover protects the objects.

The priority application, Japanese Application No. 2004-313434, which was filed on Oct. 28, 2004, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. A tongue cover for a tongue, the tongue comprising:
a plate that is configured to engage a buckle; and
a grip that is configured to facilitate engagement of the plate with the buckle,
wherein the grip is integral with the plate and is configured to be slidably supported by a belt, and
wherein the tongue cover, which is formed of a material that is softer than the grip, is provided on the grip in a manner such that the tongue cover covers edges of the grip except for an edge to which the plate is attached.

2. The tongue cover according to claim 1, wherein the tongue cover is integral with the grip of the tongue, and wherein the tongue cover is not detachable.

3. The tongue cover according to claim 1, wherein the tongue cover is separate from the tongue, wherein the tongue cover is attached to the grip of the tongue, and wherein the tongue cover is detachable from the tongue.

4. The tongue cover according to claim 3, wherein a degree of tightness at which the tongue cover holds the grip of the tongue is adjustable.

5. The tongue cover according to claim 3, wherein the tongue cover comprises:
a first binding band that has a first engaging portion; and
a second binding band that has a second engaging portion, which is configured to engage the first engaging portion.

6. The tongue cover according to claim 5, wherein the first engaging portion is in the form of a button hole and the second engaging portion is in the form of a button.

7. The tongue cover according to claim 5, wherein the first and second engaging portions are respective joining members.

8. The tongue cover according to claim 7, wherein the joining members are respective pieces of Velcro®.

9. The tongue cover according to claim 5, wherein the first engaging portion is in the form of a male snap fastener and the second engaging portion is in the form of a female snap fastener.

10. A seatbelt apparatus comprising:
a seatbelt;
a seatbelt retractor for retracting the seatbelt;
a buckle;
a tongue that is slidably supported by the seatbelt and that is configured to be inserted in, and releasably engaged with, the buckle to fasten the seatbelt, the tongue comprising:
a plate that is configured to engage the buckle; and
a grip that is configured to facilitate engagement of the plate with the buckle;
and
a tongue cover for the tongue,
wherein the grip is integral with the plate and is slidably supported by the seatbelt,
wherein the tongue cover, which is formed of a material that is softer than the grip, is provided on the grip in a manner such that the tongue cover covers edges of the grip except for an edge to which the plate is attached, and
wherein the tongue cover is attached to or is integral with the tongue.

11. The seatbelt apparatus according to claim 10, wherein a degree of tightness at which the tongue cover holds the grip of the tongue is adjustable.

12. The seatbelt apparatus according to claim 11, wherein the tongue cover comprises:
a first binding band that has a first engaging portion; and
a second binding band that has a second engaging portion, which is configured to engage the first engaging portion.

13. The seatbelt apparatus according to claim 12, wherein the first engaging portion is in the form of a button hole and the second engaging portion is in the form of a button.

14. The seatbelt apparatus according to claim 12, wherein the first and second engaging portions are respective joining members.

15. The seatbelt apparatus according to claim 14, wherein the joining members are respective pieces of Velcro®.

16. The seatbelt apparatus according to claim 12, wherein the first engaging portion is in the form of a male snap fastener the second engaging portion is in the form of a female snap fastener.
